(19) United States
(12) Patent Application Publication
(10) Pub. No.: US 2008/0266222 A1
(43) Pub. Date: Oct. 30, 2008

(54) Liquid crystal display having common voltage compensating circuit and driving method thereof

(75) Inventor: Sha Feng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOCOM TECHNOLOGY (SHENZHEN) CO., LTD.;INNOLUX DISPLAY CORP.

(21) Appl. No.: 12/150,264

(22) Filed: Apr. 25, 2008

(30) Foreign Application Priority Data
Apr. 25, 2007 (CN) 200710074215.8

(51) Int. Cl. G09G 3/36

(52) U.S. Cl. 345/87

(57) ABSTRACT

An exemplary liquid crystal display (300) includes a liquid crystal panel (301) having a plurality of pixel units (340), a common voltage generating circuit (304), and a common voltage compensating circuit (306). The common voltage compensating circuit receives display signals, and compares odd-column display signals of said display signals with even-column display signals of said display signals, so as to provide a compensating signal. The common voltage generating circuit generates a common voltage signal according to the compensating signal, and outputs the common voltage signal to the pixel units. A related method for driving a liquid crystal display is also provided.

### FIELD OF THE INVENTION

The present invention relates to a liquid crystal display (LCD) having a common voltage compensating circuit. The present invention also relates to a method for driving the LCD.

### GENERAL BACKGROUND

LCDs are widely used in various information products, such as notebooks, personal digital assistants, video cameras, and the like.

FIG. 6 is an abbreviated circuit diagram of a conventional LCD. The LCD 100 includes a liquid crystal panel 101, a scanning circuit 102, and a data circuit 103. The liquid crystal panel 101 includes n rows of parallel scanning lines 110 (where n is a natural number), m columns of parallel data lines 120 perpendicular to the scanning lines 110 (where m is also a natural number), and a plurality of pixel units 140 cooperatively defined by the crossing scanning lines 110 and data lines 120. The scanning lines 110 are electrically coupled to the scanning circuit 102, and the data lines 120 are electrically coupled to the data circuit 130.

Each pixel unit 140 includes a thin film transistor (TFT) 141, a pixel electrode 142, and a common electrode 143. A gate electrode of the TFT 141 is electrically coupled to a corresponding one of the scanning lines 110, and a source electrode of the TFT 141 is electrically coupled to a corresponding one of the data lines 120. Further, a drain electrode of the TFT 141 is electrically coupled to the pixel electrode 142. The common electrodes 143 of all the pixel units 140 are electrically coupled together and further electrically coupled to a common voltage generating circuit (not shown). In each pixel unit 140, liquid crystal molecules (not shown) are disposed between the pixel electrode 142 and the common electrode 143, so as to cooperatively form a liquid crystal capacitor 147.

In operation, the common electrodes 143 receive a common voltage signal from the common voltage generating circuit. The scanning circuit 102 provides a plurality of scanning signals to the scanning lines 110 sequentially, so as to activate the pixel units 140 row by row via switching the corresponding TFTs 141 on. The data circuit 103 provides a plurality of data voltage signals to the pixel electrodes 142 of the activated pixel units 140 via the corresponding data lines 120. Thereby, the liquid crystal capacitors 147 of the activated pixel units 140 are charged. After the charging process, an electric field is generated between the pixel electrode 142 and the common electrode 143 in each pixel unit 140. The electric field drives the liquid crystal molecules to control light transmission of the pixel unit 140, such that the pixel unit 140 displays a particular color (red, green, or blue) having a corresponding gray level. The electric field is maintained by the liquid crystal capacitor 147 during the so-called current frame period, and accordingly the gray level of the color is maintained during the current frame period.

In particular, the LCD 100 employs a dot inversion system to drive the liquid crystal molecules, such that the liquid crystal molecules can be protected from decay or damage. FIG. 7 schematically illustrates a series of polarity patterns of a matrix of 4×4 pixel units 140 of the liquid crystal panel 101 of the LCD 100 employing the dot inversion system. Other pixel units 140 of the liquid crystal panel 101 have a similar polarity arrangement.

As shown in FIG. 7, the polarity of each pixel unit 140 is opposite to the polarity of every directly adjacent pixel unit 140, and is the same as the polarity of every diagonally adjacent pixel unit 140. That is, the polarities of the pixel units 140 positioned in odd columns of the matrix are the same in each row, and are opposite to the polarities of the pixel units 140 positioned in even columns of the matrix. Moreover, the polarity of each pixel unit 140 is reversed once in every frame period.

In the LCD 100, each pixel unit 140 employs a capacitor structure (i.e. the liquid crystal capacitor 147) to retain the gray level of the color. In addition, a plurality of parasitic capacitors usually exists in the pixel unit 140. Due to a so-called capacitor coupling effect, when the corresponding data voltage signal changes, an electrical potential of the common electrode 143 may be coupled and shift from the common voltage signal. Because the pixel units 140 are activated and receive the data voltage signals row by row, the electrical potentials of the common electrodes 143 of the activated row of pixel units 140 are liable to be pulled up or pulled down simultaneously and thereby have undesired values. Moreover, because the common electrodes 143 of the activated row of pixel units 140 are electrically coupled together, the undesired values of the electrical potentials are the same.

For example, when each of the data voltage signals corresponding to the pixel units 140 positioned in odd columns has a positive polarity, and a sum of such data voltage signals is greater than that corresponding to the pixel units 140 positioned in even columns, the data voltage signals may cooperatively pull up the electrical potentials of all the common electrodes 143 of the activated row of pixel units 140. The shift of the electrical potential of the common electrode 143 may further bring on a change of the electric field between the pixel electrode 142 and the common electrode 143 in each pixel unit 140. Thereby, the gray level of the color displayed by the pixel unit 140 is apt to change, and accordingly a so-called color shift phenomenon may be generated. Thus the display quality of the LCD 100 may be somewhat unsatisfactory. Such deficiencies may also exist when the LCD 100 employs a line inversion system to drive the liquid crystal molecules.

What is needed is to provide an LCD and a driving method thereof that can overcome the above-described deficiencies.

### SUMMARY

In one aspect, a liquid crystal display includes a liquid crystal panel having a plurality of pixel units, a common voltage generating circuit, and a common voltage compensating circuit. The common voltage compensating circuit receives display signals, and compares odd-column display signals of said display signals with even-column display signals of said display signals, so as to provide a compensating signal. The common voltage generating circuit generates a common voltage signal according to the compensating signal, and outputs the common voltage signal to the pixel units.

In another aspect, a method for driving a liquid crystal display includes: providing a liquid crystal panel having a plurality of pixel units; receiving display signals corresponding to the pixel units; providing a common voltage compensating circuit; comparing odd-column display signals of said display signals with even-column display signals of said display signals via the common voltage compensating circuit to provide a compensating signal; providing a common voltage generating circuit, generating a common voltage signal according to the compensating signal via the common voltage generating circuit; and outputting the common voltage signal to the pixel units.

Other novel features and advantages will become more apparent from the following detailed description when taken in conjunction with the accompanying drawings.

### BRIEF DESCRIPTION OF THE DRAWINGS

FIG. 1 is an abbreviated circuit diagram of an LCD according to an exemplary embodiment of the present invention, the LCD including a common voltage compensating circuit.

FIG. 2 is block diagram of the common voltage compensating circuit of the LCD of FIG. 1.

FIG. 3 is flow chart of an exemplary driving method for driving the LCD of FIG. 1, the driving method including steps S1˜S8.

FIG. 4 is a flow chart of detailed processes of step S3 of the method of FIG. 3.

FIG. 5 is a flow chart of detailed processes of step S4 of the method of FIG. 3.

FIG. 6 is an abbreviated circuit diagram of a conventional LCD capable of employing a dot inversion system to drive liquid crystal molecules thereof, the LCD including a plurality of pixel units.

FIG. 7 schematically illustrates a series of polarity patterns of a matrix of 4×4 pixel units of the LCD of FIG. 6, when the LCD employs the dot inversion system.

### DETAILED DESCRIPTION OF PREFERRED EMBODIMENTS

Reference will now be made to the drawings to describe preferred and exemplary embodiments of the present invention in detail.

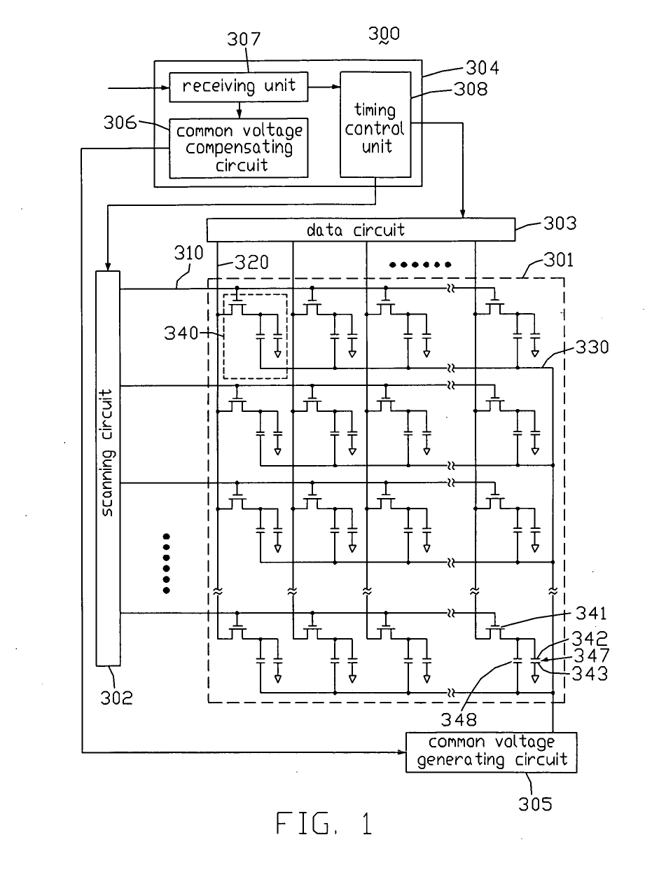

FIG. 1 is an abbreviated circuit diagram of an LCD according to an exemplary embodiment of the present invention. The LCD 300 can employ either a dot inversion system or a line inversion system to drive liquid crystal molecules thereof. The LCD 300 includes a liquid crystal panel 301, a scanning circuit 302, a data circuit 303, a timing controller 304, and a common voltage generating circuit 305.

The liquid crystal panel 301 includes n rows of parallel scanning lines 310 (where n is a natural number), n rows of parallel common lines 330 alternately arranged with the scanning lines 310, m columns of parallel data lines 320 perpendicular to the scanning lines 310 and the common lines 330 (where m is also a natural number), and a plurality of pixel units 340 cooperatively defined by the crossing scanning lines 310 and data lines 320. Thus, the pixel units 340 are arranged in a matrix having n rows and m columns. The scanning lines 310 are electrically coupled to the scanning circuit 302. The data lines 320 are electrically coupled to the data circuit 303. The common lines 330 are electrically coupled to the common voltage generating circuit 305.

Each pixel unit 340 includes a TFT 341, a pixel electrode 342, a common electrode 343, and a storage capacitor 348. A gate electrode of the TFT 341 is electrically coupled to a corresponding one of the scanning lines 310, and a source electrode of the TFT 341 is electrically coupled to a corresponding one of the data lines 320. Further, a drain electrode of the TFT 341 is electrically coupled to the pixel electrode 342. The common electrode 343 is opposite to the pixel electrode 342, with a plurality of the liquid crystal molecules (not shown) sandwiched therebetween, so as to cooperatively form a liquid crystal capacitor 347. One end of the storage capacitor 348 is electrically coupled to the pixel electrode 342, and the other end of the storage capacitor 348 is electrically to a corresponding one of the common lines 330.

The timing controller 304 includes a receiving unit 307, a timing control unit 308, and a common voltage compensating circuit 306. The receiving unit 307 is configured to receive display signals for driving the pixel units 340. The display signals include odd-column display signals and even-column display signals. In this description, odd-column display signals refer to display signals corresponding to the pixel units 340 positioned in odd columns of the matrix, and even-column display signals refer to display signals corresponding to the pixel units 340 positioned in even columns of the matrix. The timing control unit 308 is configured to control the driving timing of the scanning circuit 302 and the data circuit 303. The common voltage compensating circuit 306 is configured to provide a compensating signal for the common voltage generating circuit 305.

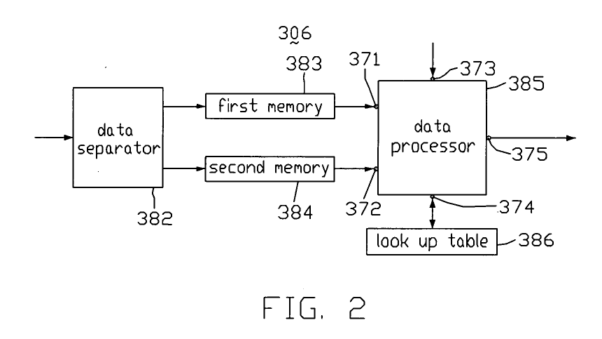

Referring also to FIG. 2, the common voltage compensating circuit 306 includes a data separator 382, a first memory 383, a second memory 384, a data processor 385, and a look up table (LUT) 386.

The data separator 382 is configured to separate the odd-column display signals from the even-column display signals. The first memory 383 and the second memory 384 are both electrically coupled to the data separator 382. The LUT 386 includes a plurality of compensating signals stored therein. Each of the compensating signals corresponds to a digital control signal provided by the data processor 385.

The data processor 385 includes a first port 371, a second port 372, a third port 373, a fourth port 374, and a fifth port 375. The first port 371 and the second port 372 are electrically coupled to the first memory 383 and the second memory 384 respectively. The third port 373 is used to receive a polarity control signal that is generated in the timing control unit 308 according to an address of the corresponding pixel unit 340. The fourth port 374 is electrically coupled to the LUT 386, and is used to read a corresponding compensating signal from the LUT 386. The fifth port 375 serves as an output port of the common voltage compensating circuit 306, and is used to output the compensating signal read by the data processor 375 to the common voltage generating circuit 305.

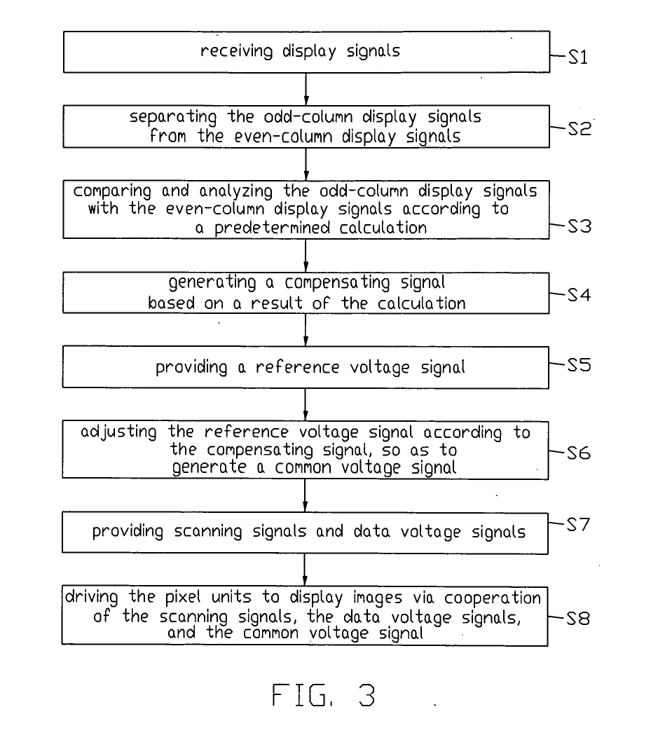

In typical operation, the LCD 300 can be driven via a driving method summarized in FIG. 3. The driving method includes: step S1, receiving display signals; step S2, separating the odd-column display signals from the even-column display signals; step S3, comparing and analyzing the odd-column display signals with the even-column display signals according to a predetermined calculation; step S4, generating a compensating signal based on a result of the calculation; step S5, providing a reference voltage signal; step S6, adjusting the reference voltage signal according to the compensating signal, so as to generate a common voltage signal; step S7, providing scanning signals and data voltage signals; and step S8, driving the pixel units to display images via cooperation of the scanning signals, the data voltage signals, and the common voltage signal.

In step S1, the display signals are received from an external circuit (not shown) by the receiving unit 307 of the timing controller 304. Each of the display signals corresponds to a respective pixel unit 340, and can be an 8-bit digital signal. Such 8-bit digital signal corresponds to 256 gray levels. For example, if the 8-bit digital signal is 00000000, it corresponds to the first gray level indicating that a brightness of the corresponding color is lowest. If the 8-bit digital signal is 11111111, it corresponds to the 256th gray level indicating that a brightness of the corresponding color is greatest.

In step S2, the display signals are separated and distributed to the first memory 383 and the second memory 384 by the data separator 382. In detail, firstly, the data separator 382 receives the display signals from the receiving unit 307; secondly, the data separator 382 separates odd-column display signals from even-column display signals; and thirdly, the data separator 382 outputs the odd-column display signals to the first memory 383, and outputs the even-column display signals to the second memory 384.

In step S3, the odd-column display signals and the even-column display signals are compared and analyzed by the data processor 385 via calculation. The calculation process can be carried out via software pre-programmed in the data processor 385. Referring to FIG. 4, step S3 can for example include: sub-step S31, reading the odd-column display signals and the even-column display signals from the first memory 383 and the second memory 384 respectively; sub-step S32, adding the odd-column display signals (e.g., 8-bit digital signals) and the even-column display signals (e.g., 8-bit digital signals) respectively to obtain a first accumulated value and a second accumulated value; and sub-step S33, subtracting the second accumulated value from the first accumulated value to obtain a calculation result.

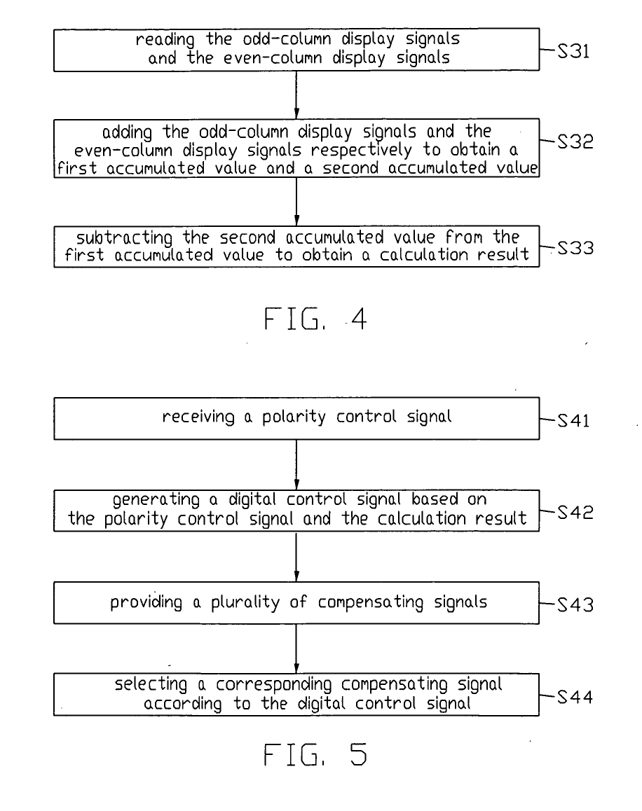

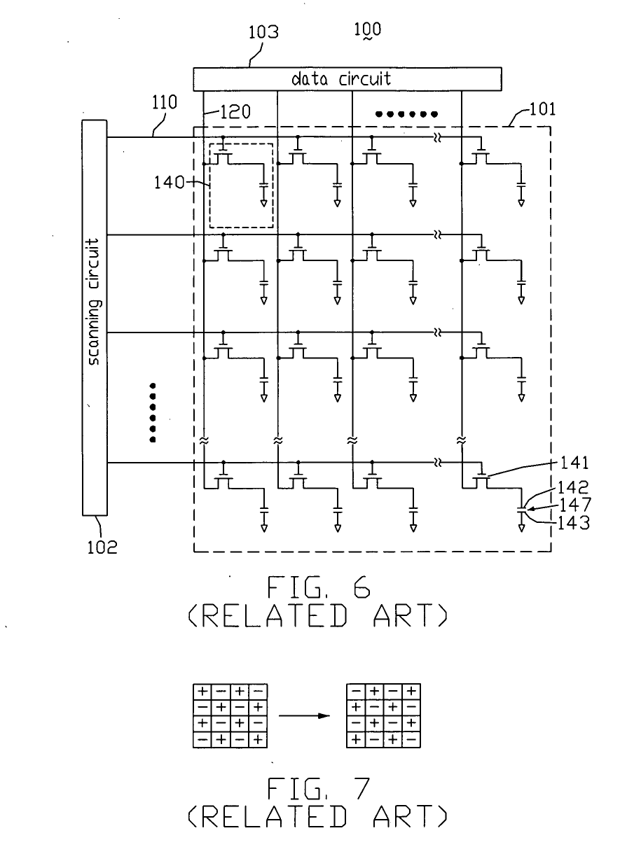

In step S4, the compensating signal is generated by the data processor 385 according to the calculation result. Referring to FIG. 5, step S4 includes: sub-step S41, receiving a polarity control signal; sub-step S42, generating a digital control signal based on the polarity control signal and the calculation result; sub-step S43, providing a plurality of compensating signals; and sub-step S44, selecting a corresponding compensating signal according to the digital control signal.

In detail, in sub-step S41, the polarity control signal corresponds to a selected one of the pixel units 340 positioned in odd columns of the matrix, and is received from the timing control unit 308 via the third port 373 of the data processor 385. In sub-step S42, the digital control signal is generated by the data processor 375 by combining the polarity control signal with the calculation result. In sub-step S43, the compensating signals are provided by the LUT 386. In sub-step S44, the corresponding compensating signal is selected by the third port 374 of the data processor 385 by reading from the LUT 386.

In step S5, the reference voltage signal is provided by the common voltage generating circuit 305. In particular, the reference voltage signal can be provided by the common voltage generating circuit 305. For example, a variable resistor (not shown) and a fixed resistor (not shown) electrically coupled in series can be provided in the common voltage generating circuit 305. A free end of the variable resistor has a power voltage signal applied thereto, and a free end of the fixed resistor is grounded. The variable resistor is predetermined to have a desired resistance, and thereby the power voltage signal is divided by the variable resistor and the fixed resistor. With this configuration, the reference voltage signal can be obtained from a node between the variable resistor and the fixed resistor.

In step S6, the reference voltage signal is adjusted by the common voltage generating circuit 305 under the control of the compensating signal. In particular, if the compensating signal represents that the polarity control signals corresponding to the odd-column display signals are positive and the calculation result is also positive, or represents that such polarity control signals are negative and the calculation result is also negative, the compensating signal controls the common voltage generating circuit 305 to pull down the reference voltage signal. If the compensating signal represents that the polarity control signals corresponding to the odd-column display signals are positive and the calculation result is negative, or represents that such polarity control signals are negative and the calculation result is positive, the compensating signal controls the common voltage generating circuit 305 to pull up the reference voltage signal. Moreover, the difference between the primary reference voltage and the adjusted reference voltage is determined by a value of the calculation result. The adjusted reference voltage signal then serves as the common voltage signal, and is outputted to the common lines 330 and the common electrodes 343.

In step S7, the scanning signals and the data voltage signals are respectively provided by the scanning circuit 302 and the data circuit 303. In detail, the scanning circuit 302 receives a timing control signal, and accordingly generates a plurality of scanning signals. The data circuit 303 receives the display signals and the polarity control signals, and accordingly generates a plurality of data voltage signals.

In step S8, the scanning circuit 302 outputs the scanning signals to the scanning lines 310 sequentially, so as to activate the pixel units 340 row by row via switching the corresponding TFTs 341 on. The data circuit 303 outputs the data voltage signals to the corresponding activated pixel units 340 via the data lines 320 and the corresponding TFTs 341. Thereby, the liquid crystal capacitors 347 in the activated row of pixel units 340 are charged. An electric field is generated between the pixel electrode 332 and the common electrode 333 in each pixel unit 340 after the charging process. The electric field drives the liquid crystal molecules of the pixel unit 340 to control the light transmission of the pixel unit 340, such that the pixel unit 340 displays a particular color (e.g., red, green, or blue) having a corresponding gray level. The aggregation of colors displayed by all the pixel units 340 simultaneously constitutes an image viewed by a user of the LCD 300.

In the LCD 300, the common voltage compensating circuit 306 is employed and provides a compensating signal for the common voltage generating circuit 305. The compensating signal controls the common voltage generating circuit 305 to adjust the reference voltage signal, so as to generate a common voltage signal. Thereby, any shift of the common voltage due to a capacitor coupling effect is compensated via the voltage adjustment, and the electric field between the pixel electrode 342 and the common electrode 343 of each pixel unit 340 can be stable during the current frame period. Accordingly, the gray level of the color displayed by the pixel unit 340 is also stable. Therefore any color shift phenomenon that might be otherwise induced because of the capacitor coupling effect is diminished or even eliminated, and the display quality of the LCD 300 is improved.

In alternative embodiments, the common voltage compensating circuit 306 of the LCD 300 can be a separate circuit from the timing controller 304, or can be integrated into the common voltage generating circuit 305.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the invention to the full-extent indicated by the broad general meaning of the terms in which the appended claims are expressed.

What is claimed is:

1. A liquid crystal display, comprising:
a liquid crystal panel comprising a plurality of pixel units;
a common voltage generating circuit; and
a common voltage compensating circuit;
wherein the common voltage compensating circuit receives display signals, and compares odd-column display signals of said display signals with even-column display signals of said display signals so as to provide a compensating signal, and the common voltage generating circuit generates a common voltage signal according to the compensating signal and outputs the common voltage signal to the pixel units.

2. The liquid crystal display as claimed in claim 1, wherein the liquid crystal panel further comprises a plurality of liquid crystal molecules at the pixel units, and employs a selected one of a dot inversion system and a line inversion system to drive the liquid crystal molecules.

3. The liquid crystal display as claimed in claim 1, wherein the common voltage compensating circuit comprises a data separator, which is configured to separate the odd-column display signals from the even-column display signals.

4. The liquid crystal display as claimed in claim 3, wherein the common voltage compensating circuit further comprises a first memory and a second memory, and the first memory and the second memory are electrically coupled to the data separator, and are respectively configured to store the odd-column display signals and the even-column display signals.

5. The liquid crystal display as claimed in claim 1, wherein the common voltage compensating circuit further comprises a data processor, and the comparison between the odd-column display signals and even-column display signal is carried out by the data processor according to a predetermined calculation.

6. The liquid crystal display as claimed in claim 5, wherein the common voltage compensating circuit further comprises a look up table, the look up table comprises a plurality of compensating signals stored therein, and each of the compensating signals corresponds to a digital control signal generated by the data processor.

7. The liquid crystal display as claimed in claim 6, wherein the data processor further comprises a port configured for receiving a polarity control signal, and the data processor generates the digital control signal according to a combination of the polarity control signal with a result of the calculation.

8. The liquid crystal display as claimed in claim 7, wherein the compensating signal is provided by the data processor via reading the look up table according to the digital control signal.

9. A method for driving a liquid crystal display, the method comprising:
providing a liquid crystal panel having a plurality of pixel units;
receiving display signals corresponding to the pixel units;
providing a common voltage compensating circuit;
comparing odd-column display signals of said display signals with even-column display signals of said display signals via the common voltage compensating circuit to provide a compensating signal;
providing a common voltage generating circuit;
generate a common voltage signal according to the compensating signal via the common voltage generating circuit; and
outputting the common voltage signal to the pixel units.

10. The method for driving a liquid crystal display as claimed in claim 9, further comprising: providing a data separator in the common voltage compensating circuit; and separating odd-column display signals from even-column display signals via the data separator.

11. The method for driving a liquid crystal display as claimed in claim 10, further comprising: providing a first memory and a second memory in the common voltage compensating circuit; and distributing the odd-column display signals and the even-column display signals to the first memory and the second memory respectively.

12. The method for driving a liquid crystal display as claimed in claim 9, further comprising: providing a data processor in the common voltage compensating circuit, wherein the odd-column display signals are compared with the even-column display signals by the data processor according to a predetermined calculation.

13. The method for driving a liquid crystal display as claimed in claim 9, wherein the comparing of the odd-column display signals with the even-column display signals comprises: adding the odd-column display signals to obtain a first accumulated value; adding the even-column display signals to obtain a second accumulated value; and subtracting the second accumulated value from the first accumulated value to obtain a calculation result.

14. The method for driving a liquid crystal display as claimed in claim 13, wherein the comparing of the odd-column display signals with the even-column display signals further comprises: receiving a polarity control signal; generating a digital control signal based on a combination of the polarity control signal with the calculation result; providing a plurality of compensating signals; and selecting a corresponding compensating signal according to the digital control signal.

15. The method for driving a liquid crystal display as claimed in claim 14, wherein the plurality of compensating signals are provided by a look up table.

16. The method for driving a liquid crystal display as claimed in claim 14, wherein the generating of a common voltage signal comprises: generating a reference voltage signal via the common voltage generating circuit; and adjusting the reference voltage signal according to the compensating signal to obtain the common voltage signal.

17. The method for driving a liquid crystal display as claimed in claim 16, wherein the reference voltage is pulled down when the calculation result and the polarity control signals corresponding to the odd-column display signals are both positive, and when the calculation result and the polarity control signals corresponding to the odd-column display signals are both negative.

18. The method for driving a liquid crystal display as claimed in claim 16, wherein the reference voltage is pulled up when the polarity control signals corresponding to the odd-column display signals are positive and the calculation result is negative, and when the polarity control signals corresponding to the odd-column display signals are negative and the calculation result is positive.
